(19) United States
(12) Patent Application Publication
(10) Pub. No.: US 2010/0257334 A1
(43) Pub. Date: Oct. 7, 2010

(54) SEMICONDUCTOR INTEGRATED CIRCUIT, INFORMATION PROCESSING DEVICE, AND CONTROL METHOD FOR SEMICONDUCTOR INTEGRATED CIRCUIT

(75) Inventor: Daisuke Kawakami, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/752,654

(22) Filed: Apr. 1, 2010

(30) Foreign Application Priority Data
Apr. 2, 2009 (JP) 2009-089876

(51) Int. Cl. G06F 12/10; G06F 12/00; G06F 12/08

(52) U.S. Cl. 711/206; 711/203; 711/E12.001; 711/E12.016; 711/E12.058

(57) ABSTRACT

A page table management circuit includes a memory control circuit including a memory unit that stores information used to convert a virtual address into a physical address with respect to each entry and designating the entry according to an input address value, and an address conversion circuit converting an input address value such that a total number of the entries to be designated by the memory control circuit is reduced and outputting the converted address value to the memory control circuit.

### INCORPORATION BY REFERENCE

This application is based upon and claims the benefit of priority from Japanese patent application No. 2009-089876, filed on Apr. 2, 2009, the disclosure of which is incorporated herein in its entirety by reference.

### BACKGROUND OF THE INVENTION

1. Field of the Invention

The present invention relates to a semiconductor integrated circuit, an information processing device, and a control method for semiconductor integrated circuit.

2. Description of Related Art

Providing a CPU (Central Processing Unit) with a TLB (Translation Lookaside Buffer) in order to convert virtual addresses into physical addresses at high speeds has been widely practiced. In general, information used to convert a virtual address into a physical address (physical page number and like) is stored for each entry in the TLB. For example, conversion from a virtual address to a physical address is implemented by reading a physical page number from a TLB based on a virtual page number contained in the virtual address and adding an offset to the read physical page number.

When a TLB exception occurs, in general, an interrupt is notified to the CPU and the TLB is replaced by the operating system. Specifically, a page table stored in the main storage device is accessed, and an entry retained in the TLB is updated. Since this process involves performing a system call to the operating system, application processes need to be kept waiting for the corresponding period. To eliminate this process overhead, the entry update for a TLB is automatically performed by means of hardware without requiring the involvement of software in some cases. In such a case, the page table is managed by dedicated hardware (dedicated storage area) instead of the main storage. A storage area corresponding to the page table needs to be secured in the main storage device or the dedicated storage area. The necessary storage area increases with an increase in the number of entries in the page table.

Japanese Unexamined Patent Application Publication No. 6-202954 discloses a technique to avoid providing separate TLBs to cope with pages having different page sizes. Specifically, a comparison bit by a tag comparison circuit is changed according to a page size code, so that the bit number of the page offset common to a logical address and a physical address becomes variable according to the page size. In this way, even if a plurality of page sizes are used, they can be coped with by a single TLB.

Incidentally, there might be cases where a new page size needs to be supported by using hardware suited for a different page size. The efficiency in product development can be improved by using existing hardware. However, according to a study made by the inventors of the present invention, when a page table is managed by means of hardware, the circuit area required for the page table stored in the dedicated storage area could increase in some cases. If the circuit area for a page table in the dedicated storage area increases, the attempt to reduce the product price is hampered. Note that this matter will become more obvious from explanation of FIGS. 1 to 3.

As obvious from the above explanation, it has been desired to support a new page size by using hardware suited for a different page size without requiring an increase in the circuit area size for the storage area in which information used to convert virtual addresses into physical address is stored.

### SUMMARY

A first exemplary aspect of the present invention is a semiconductor integrated circuit including: a memory control unit including a storage area that stores information used to convert a virtual address into a physical address with respect to each entry, the memory control designating the entry according to an input address value; and an address conversion unit converting an input address value such that a total number of the entries to be designated by the memory control unit is reduced, and outputting the converted address value to the memory control unit.

Even when a new page size is supported by hardware suited for a different page size, it can eliminate the necessity for storing entries of the same contents in a row in the storage area by address conversion by the address conversion unit. In this way, a new page size can be supported by using hardware suited for a different page size without requiring an increase in the circuit area size for the storage area.

Another exemplary aspect of the present invention is an information processing device including: a memory control circuit including a storage area that stores information used to convert a virtual address into a physical address with respect to each entry, the memory control circuit designating the entry according to an input address value; an address conversion circuit converting an input address value such that a total number of the entries to be designated by the memory control circuit is reduced, and outputting the converted address value to the memory control circuit; and a CPU core generating the address value to be input to the address conversion circuit, and including a retention area that retains one circuit of a plurality of entries stored in the storage area.

Another exemplary aspect of the present invention is a control method for a semiconductor integrated circuit, the semiconductor integrated circuit including a storage area that stores information used to convert a virtual address into a physical address with respect to each entry, the semiconductor integrated circuit being configured to designate the entry based on an input address value, the method including: converting the input address value generated by a CPU core such that a total number of the entries to be designated by the address value is reduced; and designating the entry based on the converted address value.

In accordance with an exemplary aspect of the invention, a new page size can be supported by using hardware suited for a different page size without requiring an increase in the circuit area size for a storage area in which information used to convert virtual addresses to physical addresses are stored.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is an explanatory diagram for explaining a mechanism to access a page table in a storage device when a TLB exception occurs under the condition that the page size=1 MB;

FIG. 2 is an explanatory diagram for explaining a mechanism to access a page table in a storage device when a TLB exception occurs under the condition that the page size=16 MB;

FIG. 3 is an explanatory diagram for explaining a problem that occurs in the mechanism shown in FIG. 2;

FIG. 4 is a schematic block diagram of an information processing device in accordance with a first exemplary embodiment of the present invention;

FIG. 5 is a schematic block diagram of a page table management circuit in accordance with a first exemplary embodiment of the present invention; FIG. 6 is a schematic block diagram of an address shift circuit in accordance with a first exemplary embodiment of the present invention;

FIG. 7 is a general flowchart for explaining a TLB entry update process in accordance with a first exemplary embodiment of the present invention that is carried out when a TLB exception occurs; and

FIG. 8 is an explanatory diagram for explaining a reduction in the circuit area size for a storage area used for a page table in accordance with a first exemplary embodiment of the present invention.

### DETAILED DESCRIPTION OF THE EXEMPLARY EMBODIMENTS

Exemplary embodiments of the present invention are explained hereinafter with reference to the drawings. Note that each exemplary embodiment is simplified for the sake of explanation. Since the drawings are drawn in a simplified manner, the technical scope of the present invention should not be narrowly interpreted based on the drawings. The drawings are used merely for explaining technical matters, and they do not precisely reflect the sizes of components shown in the drawings. The same signs are assigned to the same components, and duplicated explanation is omitted.

### First Exemplary Embodiment

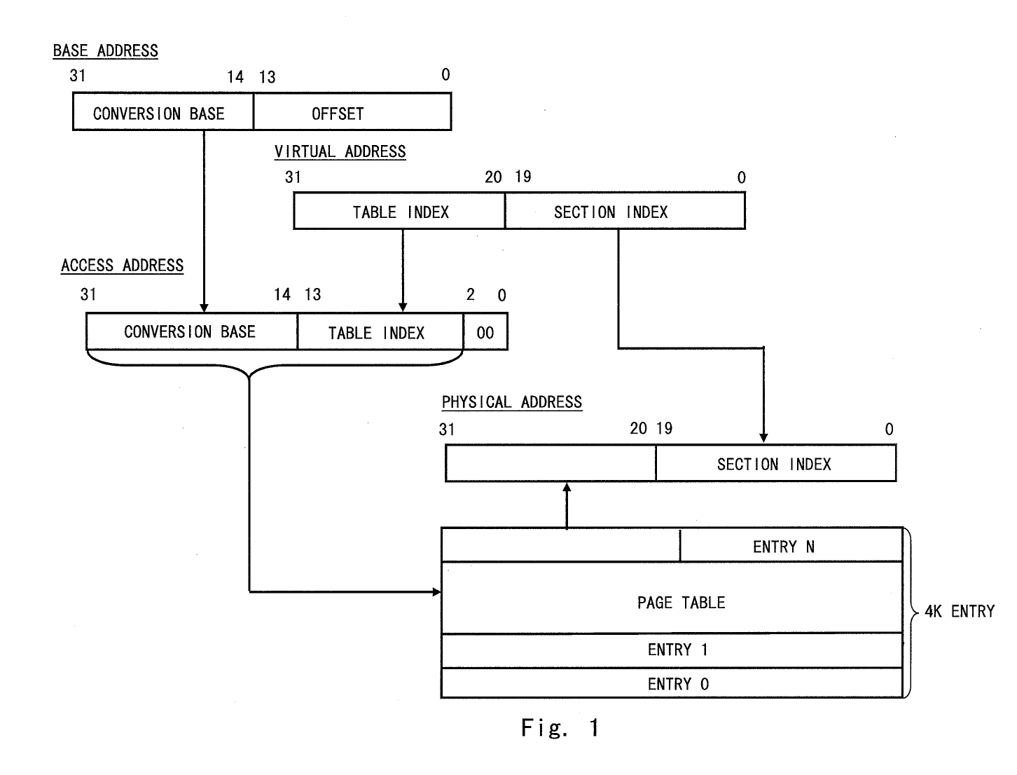

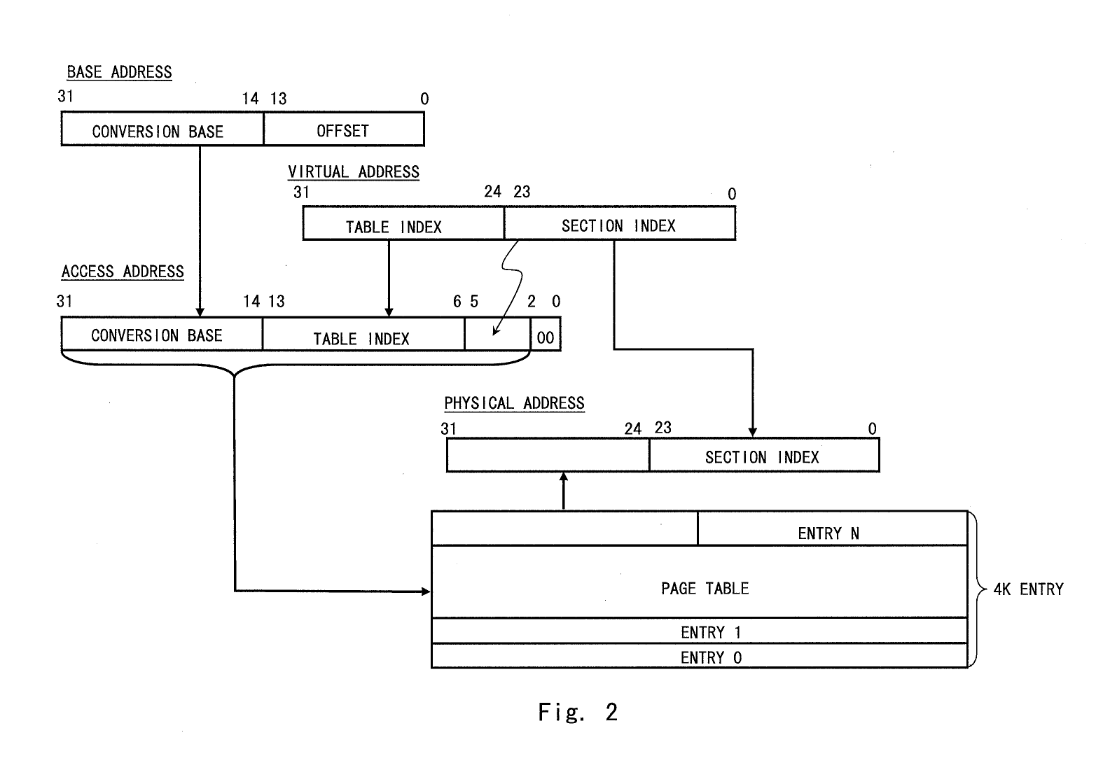

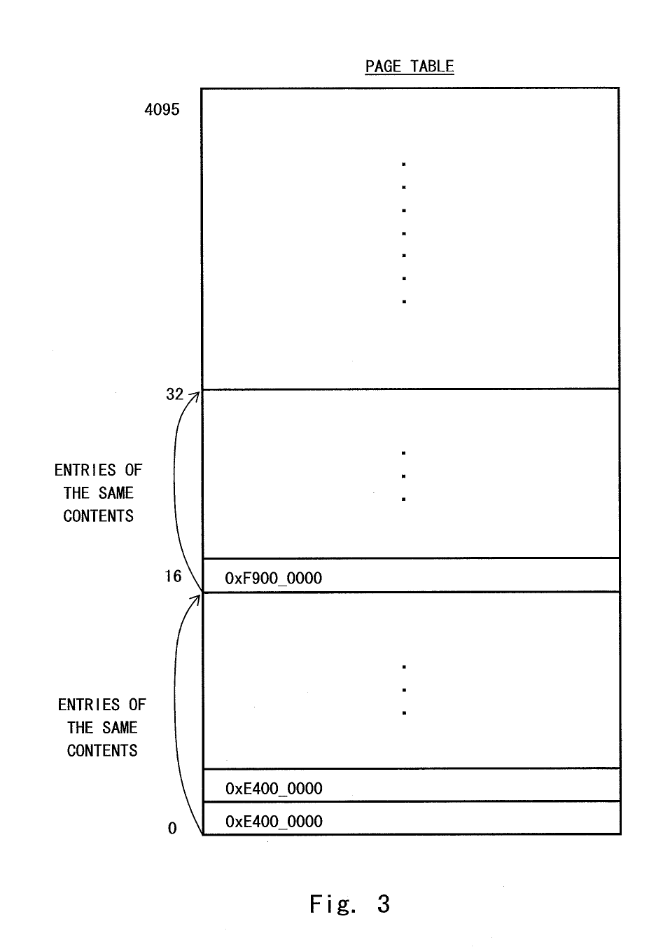

A first exemplary embodiment of the present invention is explained with reference to FIGS. 1 to 8. Firstly, a problem that occurs when a new page size is supported by using existing hardware suited for a different page size is explained with reference to FIGS. 1 to 3. FIG. 1 is an explanatory diagram for explaining a mechanism to access a page table in a storage device when a TLB exception occurs in a case where the page size=1 MB. FIG. 2 is an explanatory diagram for explaining a mechanism to access a page table in a storage device when a TLB exception occurs in a case where the page size=16 MB. FIG. 3 is an explanatory diagram for explaining a problem that occurs in the case shown in FIG. 2.

As shown in FIG. 1, assume that the page table in the storage device is optimized to the page size=1 MB. In this case, 4096 entries are prepared. Note that each entry has a 32-bit address space, and a virtual address number and a physical address number are stored in a state where they are associated with each other.

When a TLB exception occurs, an access address is generated from a base address and a virtual address number. The bit string [13:2] of the access address is used to designate an entry in the page table in the storage device. Information (physical address number and the like) read out from the designated entry is transferred to the TLB to update the TLB. In this way, it prevents a TLB exception from occurring again.

Note that in this architecture, a physical address is generated from a physical address number designated by an access address and a section index of a virtual address. In this way, a virtual address is converted into a physical address.

Next, a case where the page size=16 MB is supported by using a hardware configuration suited for the mechanism shown in FIG. 1 without changing its configuration is examined with reference to FIG. 2.

When the hardware configuration suited for the mechanism shown in FIG. 1 is used without changing its configuration, higher-order bits of the section index of a virtual address is also included in the access address in addition to the table index of the virtual address as shown in FIG. 2. In this case, the section index of the virtual address affects the designation of an entry.

For example, assume that an access address [13:2]=0x000 is generated from a virtual address=0xF800000. In this case, an access address that is generated from a different virtual address=0xF8100000 becomes an access address [13:2]=0x001. In this way, the value of an access address changes according to the section index of the virtual address. Since each access address is associated with a corresponding entry, the total number of entries increases with an increase in the number of access addresses.

In the above-described case, it becomes necessary to prepare 16 entries of the same contents in a row in the page table in the storage device to cope with the added 4-bit section index as schematically shown in FIG. 3. When the number of entries stored in the page table in the storage device increases, the circuit area size for the storage area in which the page table is stored also increases. The increase in the circuit area size could hamper the attempt to reduce the price of products to be manufactured.

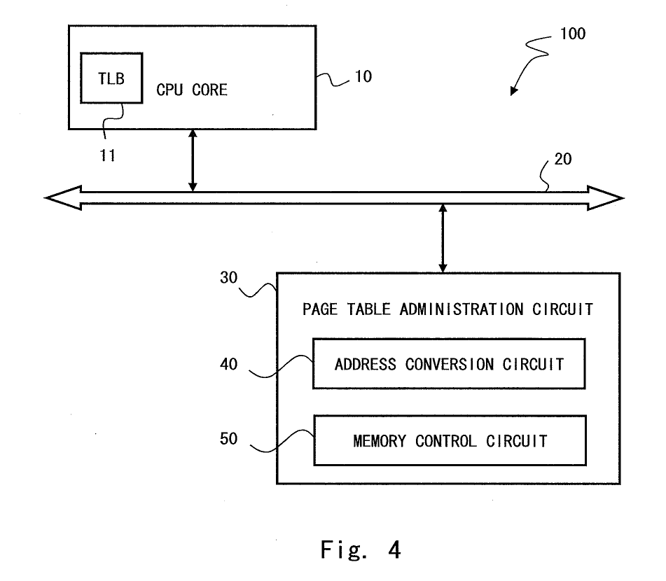

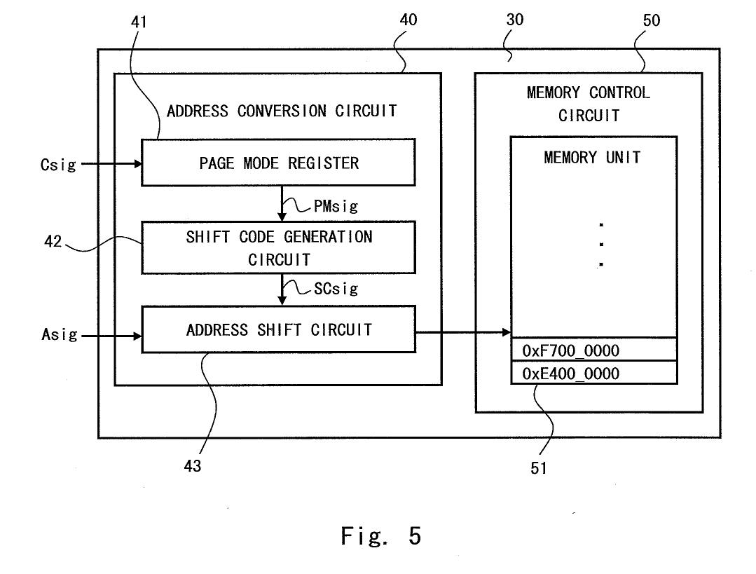

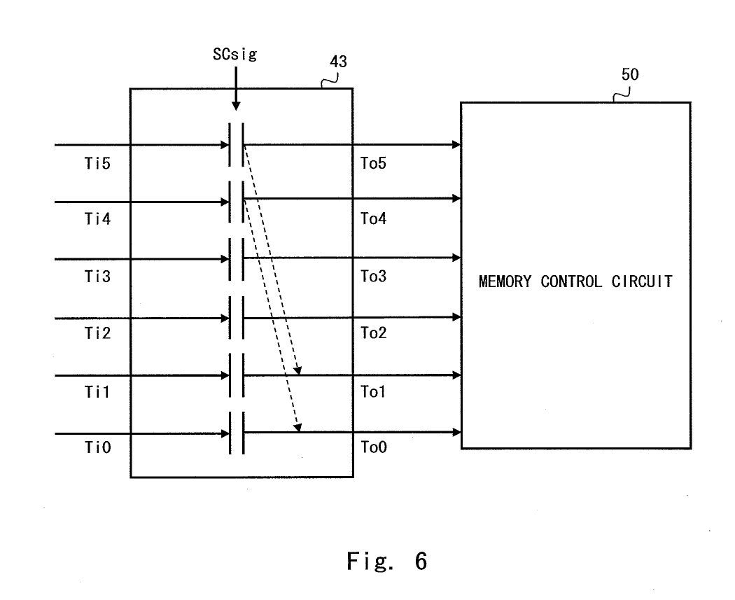

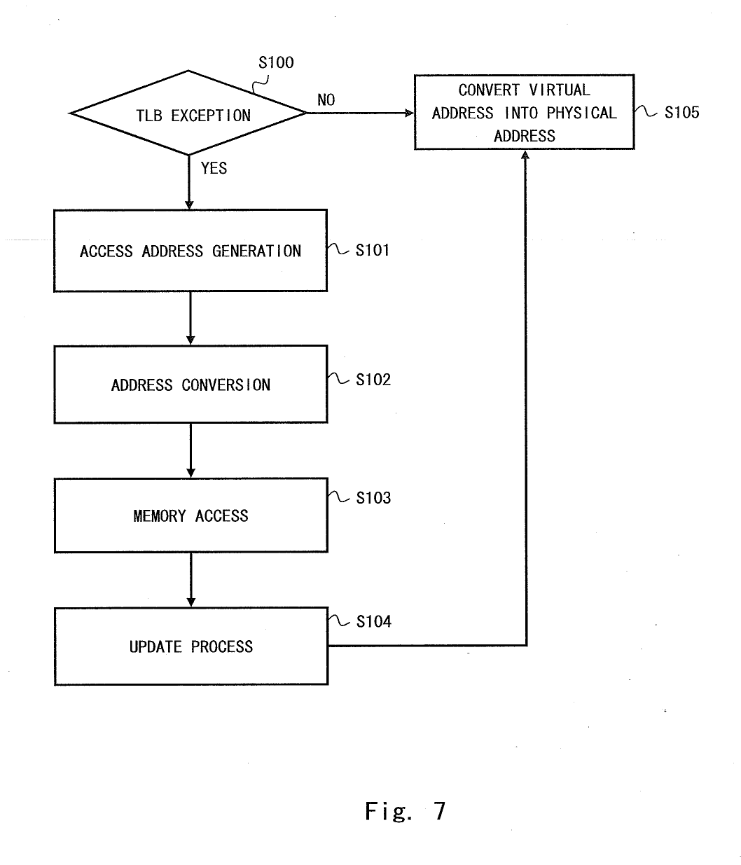

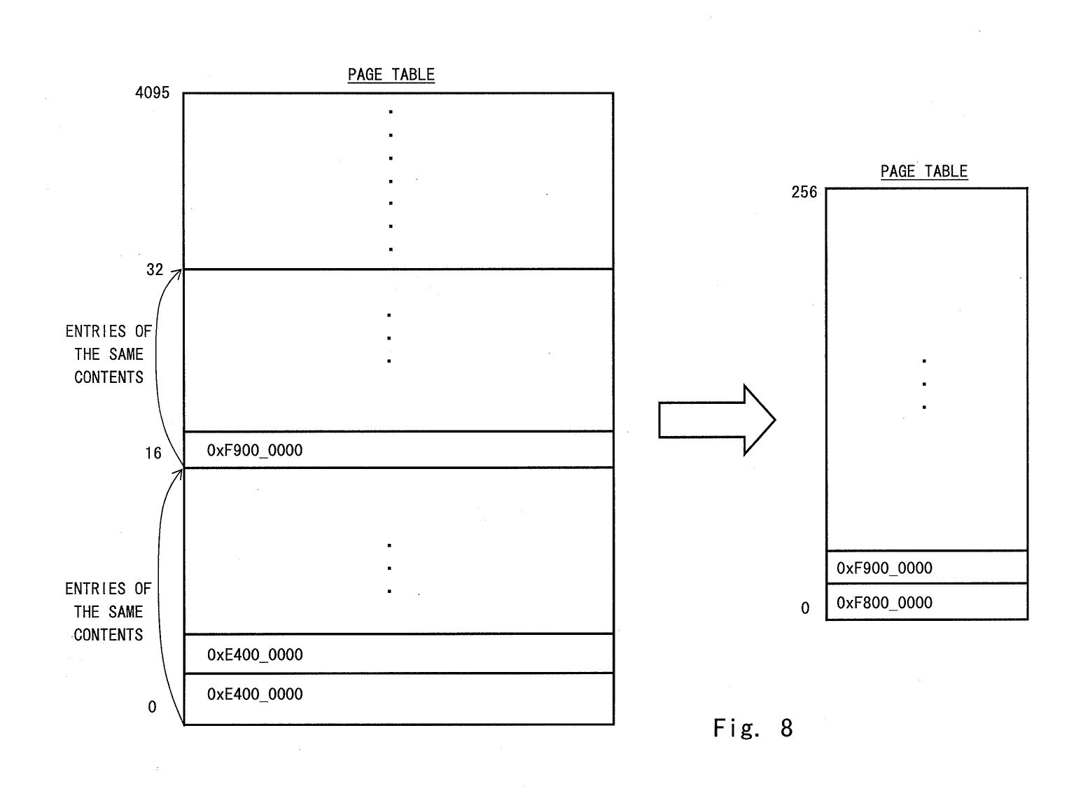

Next, a first exemplary embodiment of the present invention is explained with reference to FIGS. 4 to 8. FIG. 4 is a block diagram showing a general configuration of an information processing device. FIG. 5 is a schematic block diagram of a page table management circuit. FIG. 6 is a schematic block diagram of an address shift circuit. FIG. 7 is a general flowchart for explaining a TLB entry update process that is carried out when a TLB exception occurs. FIG. 8 is an explanatory diagram for explaining a reduction in the circuit area size for a storage area used for a page table in accordance with a first exemplary embodiment of the present invention.

As shown in FIG. 4, an information processing device 100 includes a CPU core 10, an internal bus 20, and a page table management circuit 30. The CPU core 10 includes a TLB 11. The page table management circuit 30 includes an address conversion circuit 40 and a memory control circuit 50. The CPU core 10 and the page table management circuit 30 are connected to each other through the internal bus 20.

As shown in FIG. 5, the address conversion circuit 40 includes a page mode register 41, a shift code generation circuit 42, and an address shift circuit 43. The memory control circuit 50 includes a memory unit 51. The memory unit 51 stores a page table having 4095 entries.

As will become obvious from the explanation made later, in accordance with this exemplary embodiment, even when existing hardware is used, it is possible to support a page size different from the one supported by the existing hardware while avoiding the increase in the total number of entries stored in the page table. Therefore, it is possible to support a page size different from the existing page size by using existing hardware without requiring an increase in the circuit area size for a storage area used for the page table (storage area in which information used to convert virtual addresses into physical addresses is stored).

As shown in FIG. 5, a page mode setting signal Csig is input to the page mode register 41. An output signal PMsig from the page mode register 41 is input to the shift code generation circuit 42. An output signal SCsig from the shift code generation circuit 42 is input to the address shift circuit 43. An access address Asig is also supplied to the address shift circuit 43.

The page mode setting signal Csig is generated by the CPU core 10 and transmitted from the CPU core 10 to the page mode register 41 through the internal bus 20. The access address Asig is generated by the CPU core 10 and transmitted from the CPU core 10 to the page mode register 41 through the internal bus 20.

As schematically shown in FIG. 6, the address shift circuit 43 converts an access address and outputs the converted access address.

When the input signal SCsig instructs an address shift by four bits, the address shift circuit 43 shifts the access address by four bits as schematically shown in FIG. 6. By the shift of the access address by four bits, the lower-order four bits are removed from the access address. Note that the lower-order four bits correspond to the higher-order four bits of the section index of the virtual address (see FIG. 2). The access address [13:2] input to the address shift circuit 43 is converted into an access address [8:2] by discarding the lower-order four bits [5:2], and output from the address shift circuit 43.

The amount of the shift by the address shift circuit 43 is set by an instruction from the

CPU core 10. Specifically, the amount of the shift by the address shift circuit 43 is determined based on a retention value in the page mode register 41 that is set by the CPU core 10.

When a page size of 16 MB is to be supported, the CPU core 10 outputs a page mode setting signal Csig to the page mode register 41. As a result, the retention value of the page mode register 41 is controlled so as to indicate the page size that is supposed to be currently supported, i.e., the page size=16 MB. The page mode register 41 outputs the retention value indicating the page size=16 MB as a signal PMsig to the shift code generation circuit. According to the signal PMsig, the shift code generation circuit 42 outputs a control signal SCsig to the address shift circuit 43 and controls the address shift circuit 43 so that an address shift by four bits occurs. The address shift circuit 43, which is controlled by the shift code generation circuit 42, shifts the input access address by four bits. In this way, an access address, which is masked by four bits in comparison to the input access address, is output from the address shift circuit 43.

Note that the amount of shift by the address shift circuit 43 is not limited to four bits. This exemplary embodiment is explained on the assumption that a page size=16 MB is supported by hardware suited for the page size=1 MB. From this relation, the amount of shift by the address shift circuit 43 is set to four bits.

Depending on the retention value of the page mode register 41, the address conversion circuit 40 can operate in a mode in which an input access address is output without performing any conversion on it. However, this exemplary embodiment is configured on the proposition that the page size=16 MB is supported in hardware suited for the page size=1 MB. Therefore, the retention value of the page mode register 41 is preferably not changed while the information processing device 100 is in operation.

The memory control circuit 50 specifies a corresponding entry based on the access address transmitted from the address shift circuit 43. Then, the memory control circuit 50 reads information (physical address number and the like) contained in the specified entry, and transmits the read information to the CPU core 10 through the internal bus 20.

An operation of the information processing device 100 is explained with reference to FIG. 7.

Firstly, assume that a TLB exception occurs (S100). Specifically, the CPU core 10 accesses the TLB 11 to convert a virtual address into a physical address. However, there is no corresponding entry in the TLB 11, and thus a TLB exception occurs.

Next, the CPU core 10 generates an access address (S101). Specifically, the CPU core 10 generates an access address in the method shown in FIG. 2. Note that an access address generated in the CPU core 10 contains the higher-order four bits of the section index of the virtual address.

Next, an address conversion is performed (S102). Specifically, the address conversion circuit 40 converts an access address in the manner described above, and outputs the converted access address to the memory control circuit 50. Note that in this process, a bit string corresponding to the higher-order four bits of the section index of the virtual address is removed. As a result, it can eliminate the necessity for preparing 16 duplicated entries in advance in the page table stored in the memory unit 51.

Next, memory access is performed (S103). Specifically, the memory control circuit 50 specifies a corresponding entry from the access address transmitted from the address shift circuit. The memory control circuit 50 reads desired information (physical address number and the like) from the entry, and transmits it to the CPU core 10.

Next, an update process is performed (S104). Specifically, the CPU core 10 stores information (physical address number and the like) transmitted from the memory control circuit 50 in an entry in the TLB 11. In this way, the TLB 11 is updated.

Next, a virtual address is converted into a physical address (S105). Specifically, the CPU core 10 uses the updated TLB 11 to convert a virtual address into a physical address. Specifically, the CPU core 10 reads a physical page number from the TLB 11 based on a virtual page number contained in the virtual address, and generates a physical address by adding an offset to the read physical page number. Then, the CPU core 10 accesses data at an address designated by the generated physical address. In this way, it is ensured that even if a TLB exception occurs, a virtual address is converted into a physical address by the update process of the TLB 11.

As obvious from the above explanation, in this exemplary embodiment, the number of entries can be reduced in comparison to a case where no measure is taken as shown in FIG. 8. Therefore, the circuit area size for the storage area that is allocated for the page table can be effectively reduced. In this way, a page size of 16 MB can be supported by existing hardware that originally supports a page size of 1 MB without requiring an increase in the circuit area size.

Note that the present invention is not limited to the above-described exemplary embodiments, and they can be modified as appropriate without departing the spirit of the present invention. The page size to be supported is not limited to 16 MB, and may be arbitrarily selected. Any given conversion method can be used to convert the access address. The access address may be also converted by any method other than the methods that are interpreted as a shift or a mask.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor integrated circuit comprising:
a memory control unit comprising a storage area that stores information used to convert a virtual address into a physical address with respect to each entry, and designating the entry according to an input address value; and
an address conversion unit converting an input address value such that a total number of the entries to be designated by the memory control unit is reduced, and outputting the converted address value to the memory control unit.

2. The semiconductor integrated circuit according to claim 1, wherein a bit number of the address value used to designate the entry that is input to the address conversion unit is smaller than a bit number of the address value that is output from the address conversion unit.

3. The semiconductor integrated circuit according to claim 1, wherein the address value to be input to the address conversion unit is generated by a CPU core and transmitted from the CPU core to the address conversion unit through an internal bus.

4. The semiconductor integrated circuit according to claim 1, wherein the address conversion unit converts an input address value according to an address conversion signal that is transmitted through an internal bus, and outputs the converted address value to the memory control unit.

5. The semiconductor integrated circuit according to claim 1, wherein the address conversion unit can operate in a mode in which the input address value is output to the memory control unit without performing any conversion.

6. The semiconductor integrated circuit according to claim 1, wherein the address conversion unit is configured so as not to operate in a mode in which the input address value is output to the memory control unit without performing any conversion.

7. An information processing device comprising:
a memory control circuit comprising a storage area that stores information used to convert a virtual address into a physical address with respect to each entry, and designating the entry according to an input address value;
an address conversion circuit converting an input address value such that a total number of the entries to be designated by the memory control circuit is reduced, and outputting the converted address value to the memory control circuit; and
a CPU core generating the address value to be input to the address conversion circuit, and comprising a retention area that retains one circuit of a plurality of entries stored in the storage area.

8. The information processing device according to claim 7, wherein a content of the entry stored in the storage area is reflected on the retention area according to an instruction by the CPU core.

9. The information processing device according to claim 7, wherein a bit number of the address value used to designate the entry that is input to the address conversion circuit is smaller than a bit number of the address value that is output from the address conversion circuit.

10. A control method for a semiconductor integrated circuit, the semiconductor integrated circuit comprising a storage area that stores information used to convert a virtual address into a physical address with respect to each entry, the semiconductor integrated circuit being configured to designate the entry based on an input address value, the method comprising:
converting the input address value generated by a CPU core such that a total number of
the entries to be designated by the address value is reduced; and
designating the entry based on the converted address value.
